(19) United States
(12) Patent Application Publication
(10) Pub. No.: US 2013/0100382 A1
(43) Pub. Date: Apr. 25, 2013

(54) LIGHT GUIDE PLATE, BACKLIGHT MODULE AND LIQUID CRYSTAL DISPLAY DEVICE

(71) Applicants: Kuang-Yao Chang, Shenzhen (CN); Lei Sun, Shenzhen (CN)

(72) Inventors: Kuang-Yao Chang, Shenzhen (CN); Lei Sun, Shenzhen (CN)

(73) Assignee: Shenzhen China Star Optoelectronics Technology Co., Ltd., Shenzhen, Guangdong (CN)

(21) Appl. No.: 13/380,888

(22) PCT Filed: Nov. 8, 2011
(86) PCT No.: PCT/CN2011/081941

§ 371 Date: Dec. 26, 2011

(30) Foreign Application Priority Data
Oct. 24, 2011 (CN) 201120408298.1

(51) Int. Cl. G02F 1/13357; F21V 8/00

(52) U.S. Cl. 349/65; 362/621

(57) ABSTRACT

A light guide plate is an optical transmissive plate and comprises at least one light incident surface for receiving light rays, one light exiting surface intersecting with the light incident surface, and one bottom surface opposite to the light exiting surface and formed with a plurality of grooves. The grooves are arranged perpendicularly to the light incident surface for adjusting a distance between a first grooves near the light incident surface and the light incident surface. Since a distance between the first microstructure near the light incident surface and the light incident surface is adjusted without modifying the light coupling distance, the hot-spot phenomenon can be reduced without increasing the cost of the light guide plate. Other grooves are arranged at increasing density and are slightly different for improving uniformity of the light rays outputted and luminance of the backlight module comprising the light guide plate.

BACKGROUND

1. Technical Field

The present disclosure relates to the field of liquid crystal displaying technologies, and more particularly, to a light guide plate, a backlight module and a liquid crystal display (LCD) device.

2. Description of Related Art

Owing to their advantages such as light weight, thin profile and low power consumption, LCD devices are widely used in modern information apparatuses including notebook computers, mobile phones and personal digital assistants (PDAs). Because liquid crystals cannot emit light by themselves, a light source system must be provided in order to achieve the displaying function. In most of conventional backlight modules, an edge-lit design using light emitting diodes (LEDs) is adopted, in which case a light guide plate becomes indispensable.

In the conventional backlight modules, a light guide plate with microstructures is usually used. The light guide plate operates in the following principle: by modifying the geometry of a lower surface of the light guide plate, total reflection of light rays propagating in the light guide plate can be disrupted, so that the light rays are exported in a non-scattering manner.

In the conventional backlight modules, a light coupling distance between the LEDs and the light guide plate is about 0.3 mm, and a pitch of the microstructures is about 0.65 mm. In this case, a part of light rays into the light guide plate are totally reflected by the first microstructure, while the remaining part of the light rays continue to propagate in the light guide plate until they meet a next microstructure. Consequently, a brightness gradient is formed between the two microstructures near the light incident side of the light guide plate, and this causes the so-called hot-spot phenomenon near the light incident side of the light guide plate, which adversely affects quality of the whole backlight module.

### BRIEF SUMMARY

The primary objective of the present disclosure is to provide a light guide plate, which is intended to improve quality of the light guide plate by reducing the influence of the hot-spot phenomenon without the need of changing a light coupling distance between the LEDs and the light guide plate.

To achieve the aforesaid objective, the present disclosure provides a light guide plate, which is a optical transmissive plate and comprises at least one light incident surface for receiving light rays, one light exiting surface intersecting with the light incident surface, and one bottom surface opposite to the light exiting surface and formed with a plurality of grooves. The grooves are arranged on the bottom surface in a direction perpendicular to the light incident surface, and a first one of the grooves that is near the side of the light incident surface is 7.3 mm to 10.3 mm from the light incident surface.

Preferably, each of the grooves has a cross section in a V-shape, a U-shape, an arc-shape or a trapezoidal shape.

Preferably, the grooves are distributed at a density that increases in a direction away from the light incident surface.

Preferably, the grooves are distributed at a density increasing from both ends of the light guide plate to a center of the light guide plate.

Preferably, the light guide plate is in the form of a flat plate.

The present disclosure further provides a backlight module comprising a light guide plate. The light guide plate is a optical transmissive plate and comprises at least one light incident surface for receiving light rays, one light exiting surface intersecting with the light incident surface, and one bottom surface opposite to the light exiting surface and formed with a plurality of grooves. The grooves are arranged on the bottom surface in a direction perpendicular to the light incident surface, and a first one of the grooves that is near the side of the light incident surface is 7.3 mm to 10.3 mm from the light incident surface.

Preferably, each of the grooves has a cross section in a V-shape, a U-shape, an arc-shape or a trapezoidal shape.

Preferably, the grooves are distributed at a density that increases in a direction away from the light incident surface.

Preferably, the grooves are distributed on the light guide plate at a density increasing from both ends of the light guide plate to a center of the light guide plate.

Preferably, the whole light guide plate is in the form of a flat plate.

The present disclosure further provides a liquid crystal display (LCD) device comprising a backlight module. The backlight module comprises a light guide plate. The light guide plate is a optical transmissive plate and comprises at least one light incident surface for receiving light rays, one light exiting surface intersecting with the light incident surface, and one bottom surface opposite to the light exiting surface and formed with a plurality of grooves. The grooves are arranged on the bottom surface in a direction perpendicular to the light incident surface, and a first one of the grooves that is near the side of the light incident surface is 7.3 mm to 10.3 mm from the light incident surface.

Preferably, each of the grooves has a cross section in a V-shape, a U-shape, an arc-shape or a trapezoidal shape.

Preferably, the grooves are distributed at a density that increases in a direction away from the light incident surface.

Preferably, the grooves are distributed on the light guide plate at a density increasing from both ends of the light guide plate to a center of the light guide plate.

Preferably, the whole light guide plate is in the form of a flat plate.

In the light guide plate of the present disclosure, a distance between the first microstructure at the side of the light incident surface and the light incident surface is adjusted without modifying the light coupling distance. This reduces the hot-spot phenomenon without increasing the manufacturing cost of the light guide plate, thus improving quality of the whole light guide plate. Furthermore, because other grooves are arranged at an increasing density and slight changes exist between these grooves, uniformity of the light rays is satisfied and luminance of the backlight module comprising the light guide plate can be improved.

### BRIEF DESCRIPTION OF THE DRAWINGS

FIG. 1 is a schematic partial cross-sectional view of a first embodiment of a light guide plate according to the present disclosure;

FIG. 2 is a schematic partial cross-sectional view of a second embodiment of the light guide plate according to the present disclosure;

FIG. 3 is a schematic partial cross-sectional view of a third embodiment of the light guide plate according to the present disclosure;

FIG. 4 is a schematic partial cross-sectional view of a fourth embodiment of the light guide plate according to the present disclosure; and

FIG. 5 is a schematic partial cross-sectional view of a fifth embodiment of the light guide plate according to the present disclosure.

Hereinafter, implementations, functional features and advantages of the present disclosure will be further described with reference to embodiments thereof and the attached drawings.

### DETAILED DESCRIPTION

The technical solutions of the present disclosure will be further described hereinbelow with reference to the attached drawings and embodiments thereof. It shall be understood that, the embodiments described herein are only intended to illustrate but not to limit the present disclosure.

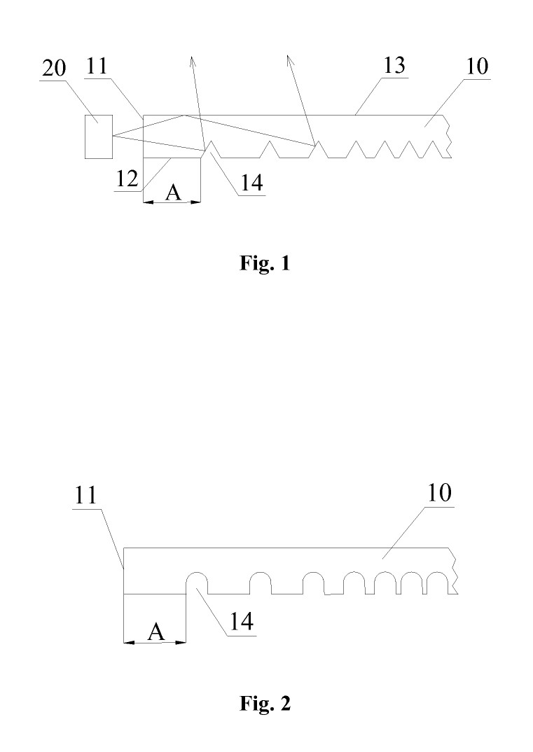

Referring to FIG. 1, there is shown a schematic partial cross-sectional view of a first embodiment of a light guide plate 10 according to the present disclosure.

In this embodiment, the light guide plate 10 is a optical transmissive plate made from acrylic resins, polycarbonate, polyethylene resins or any other material having a high reflectivity and absorbing no light, and is in the form of a flat plate. The light guide plate 10 comprises one light incident surface 11 for receiving light rays from a light source 20, one light exiting surface 13 intersecting with the light incident surface 11, and one bottom surface 12 opposite to the light exiting surface. The bottom surface 12 is formed with a plurality of grooves 14, each of which has a cross section in a V-shape and extends in parallel with the light incident surface 11. The grooves 14 are adapted to disrupt total internal reflection of light rays in the light guide plate 10. The grooves 14 are arranged on the bottom surface 12 in a direction perpendicular to the light incident surface 11, and are distributed at a density that increases in a direction away from the light incident surface 11. This increases uniformity of the light guiding effect of the whole light guide plate 10. A distance A between a first one of the grooves 14 in the direction away from the light incident surface 11 and the light incident surface 11 is 7.3 mm to 10.3 mm

After being coupled to the light guide plate 10, the light rays from the light source 20 can be completely exported from the light exiting surface 13 because total reflection of light rays propagating on the bottom surface 12 of the light guide plate 10 are disrupted by the grooves 14. However, in the prior art, the first groove 14 and the light incident surface 11 has a small distance therebetween, so a brightness gradient is generated between the first groove 14 and a next groove 14. Consequently, luminance at a position of the first groove 14 of the light guide plate 10 is significantly greater than that at other positions; i.e., the hot-spot phenomenon is caused.

After light at a certain intensity is inputted to the light guide plate 10, if it is measured that a distance between the light incident surface 11 of the light guide plate and the first groove 14 is 0.5 mm, then a luminance value at the hot spot formed is about 250 cd/m² and a luminance value at a central position on the light guide plate 10 is about 100 cd/m² which is much smaller than the luminance value at the hot spot. This means that the hot-spot phenomenon is remarkable. In order to make the light guide plate 10 operate normally without being affected by the hot-spot phenomenon, a width of a plastic frame has to be increased to cover up the hot-spot phenomenon. However, this causes light to be scattered and absorbed by the plastic frame and, consequently, causes waste of light energy. When the distance between the light incident surface 11 of the light guide plate and the first groove 14 is increased to 7 mm, the position at which light is extracted for the first time is drawn back. Then, the luminance value at the hot spot formed is about 120 cd/m² and the luminance value at the central position on the light guide plate 10 is about 100 cd/m² which is approximate to the luminance value at the hot spot. Therefore, the hot-spot phenomenon is significantly reduced. Meanwhile, the grooves 14 are distributed at a density that increases in the direction away from the light incident surface 11, so most of light rays emitted from light emitting diodes (LEDs) are extracted by the light guide plate, thereby reducing the influence of the hot-spot phenomenon on the light guide plate 10. This improves quality of the light guide plate 10, satisfies uniformity of the light guiding effect, and avoids waste of light energy. When the distance between the light incident surface 11 of the light guide plate and the first groove 14 becomes 10 mm, the luminance value at the hot spot formed is about 100 cd/m² and the luminance value at the central position on the light guide plate 10 is also about 100 cd/m² which is substantially equal to the luminance value at the hot spot. This means that the hot-spot phenomenon is substantially eliminated. Therefore, the light guide plate 10 is not affected by the hot-spot phenomenon.

The grooves 14 disposed on the bottom surface 12 of the light guide plate 10 have substantially the same depth, but slight changes exist between these grooves 14. That is, vertex angles of the grooves 14 may be different from each other, and may gradually increase or decrease in the direction away from the light incident surface 11; and additionally, the V-shaped cross section of each of the grooves 14 may have different lengths at two sides thereof. According to such factors as the actual size of the light guide plate 10, the shape of the light incident surface 11 and the brightness of the light source 20, the shape of each of the grooves 14 may be appropriately adjusted in the manufacturing process in order to increase the uniformity of the light rays outputted from the light guide plate 10.

Referring to FIG. 2, there is shown a schematic partial cross-sectional view of a second embodiment of the light guide plate 10 according to the present disclosure.

This embodiment differs from the first embodiment in that: in this embodiment, each of the grooves 14 has a cross section in a U-shape. The grooves 14 have substantially the same depth, but slight changes may also exist between these grooves 14. That is, top curved surfaces of the grooves 14 may have different radiuses of curvature, and the radiuses of curvature of the curved surfaces may gradually increase or decrease in the direction away from the light incident surface 11; and additionally, the U-shaped cross section of each of the grooves 14 may also have different lengths at two sides thereof.

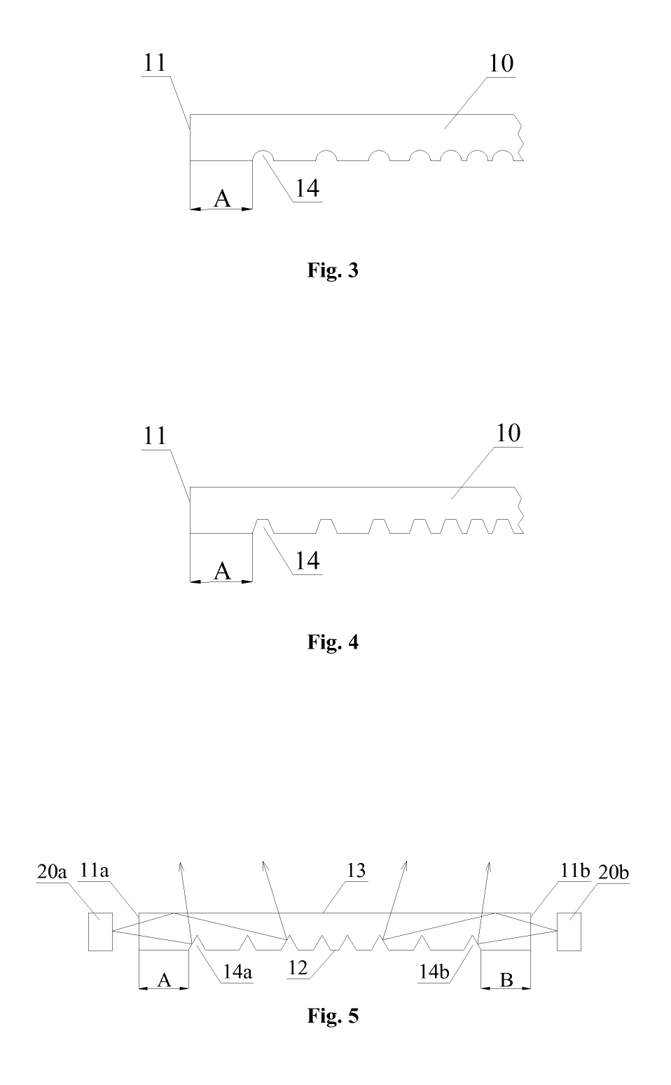

Referring to FIG. 3, there is shown a schematic partial cross-sectional view of a third embodiment of the light guide plate 10 according to the present disclosure.

This embodiment differs from the first embodiment in that: in this embodiment, each of the grooves 14 has a cross section in an arc-shape. The grooves 14 have substantially the same depth, but slight changes may also exist between these grooves 14. That is, top curved surfaces of the grooves 14 may have different radiuses of curvature, and the radiuses of curvature of the curved surfaces may gradually increase or decrease in the direction away from the light incident surface 11.

Referring to FIG. 4, there is shown a schematic partial cross-sectional view of a fourth embodiment of the light guide plate 10 according to the present disclosure.

This embodiment differs from the first embodiment in that: in this embodiment, each of the grooves 14 has a cross section in a trapezoidal shape. The trapezoidal grooves 14 disposed on the light guide plate 10 have substantially the same height, but slight changes may also exist between these grooves 14. That is, upper bottoms of the trapezoidal grooves 14 may have different lengths, and two sides of each of the trapezoidal grooves 14 may or may not be equal to each other.

Referring to FIG. 5, there is shown a schematic cross-sectional view of a fifth embodiment of the light guide plate 10 according to the present disclosure.

This embodiment differs from the first embodiment in that: in this embodiment, the light guide plate 10 comprises a first light incident surface 11a and a second light incident surface 11b which are opposite to each other and correspond to a first light source 20a and a second light source 20b respectively. The grooves 14 are symmetrically arranged on the bottom surface 12 of the light guide plate 10 at a density increasing from both ends of the light guide plate 10 to a center of the light guide plate 10. A distance A between the first groove 14a and the first light incident surface 11a is equal to a distance B between the second groove 14b and the second light incident surface 11b, and ranges from 7.3 mm to 10.3 mm. Light rays of the first light source 20a and the second light source 20b pass into the light guide plate 10 from the first light incident surface 11a and the second light incident surface 11b respectively, and are then reflected by the grooves 14 disposed on the bottom surface 12 of the light guide plate 10 to exit from the light exiting surface 13. In this embodiment, the use of the first light source 20a and the second light source 20b can increase the luminance of the light guide plate 10. In this embodiment, each of the grooves 14 has a cross section in a V-shape; and each of the grooves 14 may also have a cross section in a U-shape, an arc-shape or a trapezoidal shape, which will be readily appreciated with reference to the second embodiment, the third embodiment or the fourth embodiment and, thus, will not be further described herein.

The present disclosure further relates to a backlight module comprising the light guide plate 10. The characteristics of the light guide plate 10 will be readily appreciated with reference to the first embodiment, the second embodiment, the third embodiment, the fourth embodiment and the fifth embodiment and, thus, will not be further described herein.

The present disclosure further relates to a liquid crystal display (LCD) device, which comprises the aforesaid backlight module comprising the light guide plate 10. Likewise, the characteristics of the light guide plate 10 will be readily appreciated with reference to the first embodiment, the second embodiment, the third embodiment, the fourth embodiment and the fifth embodiment and, thus, will not be further described herein.

In the light guide plate 10 of the present disclosure, a distance between the first microstructure 14 at the side of the light incident surface 11 and the light incident surface 11 is adjusted without modifying the light coupling distance. This reduces the hot-spot phenomenon without increasing the manufacturing cost of the light guide plate 10, thus improving quality of the whole light guide plate 10. Furthermore, because other grooves 14 are arranged at an increasing density and slight changes exist between these grooves 14, uniformity of the light rays outputted from the light guide plate 10 is satisfied and luminance of the backlight module comprising the light guide plate 10 can be improved.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

What is claimed is:

1. A light guide plate, which is a optical transmissive plate and comprises at least one light incident surface for receiving light rays, one light exiting surface intersecting with the light incident surface, and one bottom surface opposite to the light exiting surface and formed with a plurality of grooves, wherein the grooves are arranged on the bottom surface in a direction perpendicular to the light incident surface, and a first one of the grooves that is near the side of the light incident surface is 7.3 mm to 10.3 mm from the light incident surface.

2. The light guide plate of claim 1, wherein each of the grooves has a cross section in a V-shape, a U-shape, an arc-shape or a trapezoidal shape.

3. The light guide plate of claim 2, wherein the grooves are distributed at a density that increases in a direction away from the light incident surface.

4. The light guide plate of claim 2, wherein the grooves are distributed on the light guide plate at a density increasing from both ends of the light guide plate to a center of the light guide plate.

5. The light guide plate of claim 2, wherein the whole light guide plate is in the form of a flat plate.

6. A light guide plate, which is a optical transmissive plate and comprises at least one light incident surface for receiving light rays, one light exiting surface intersecting with the light incident surface, and one bottom surface opposite to the light exiting surface and formed with a plurality of grooves, wherein the grooves are arranged on the bottom surface in a direction perpendicular to the light incident surface, a first one of the grooves that is near the side of the light incident surface is 7.3 mm to 10.3 mm from the light incident surface, and the grooves are distributed at a density that increases in a direction away from the light incident surface or the grooves are distributed on the light guide plate at a density increasing from both ends of the light guide plate to a center of the light guide plate.

7. The light guide plate of claim 6, wherein each of the grooves has a cross section in a V-shape, a U-shape, an arc-shape or a trapezoidal shape.

8. The light guide plate of claim 7, wherein the whole light guide plate is in the form of a flat plate.

9. A backlight module comprising a light guide plate, wherein the light guide plate is a optical transmissive plate and comprises at least one light incident surface for receiving light rays, one light exiting surface intersecting with the light incident surface, and one bottom surface opposite to the light exiting surface and formed with a plurality of grooves, the grooves are arranged on the bottom surface in a direction perpendicular to the light incident surface, and a first one of the grooves that is near the side of the light incident surface is 7.3 mm to 10.3 mm from the light incident surface.

10. The backlight module of claim 9, wherein each of the grooves has a cross section in a V-shape, a U-shape, an arc-shape or a trapezoidal shape.

11. The backlight module of claim 10, wherein the grooves are distributed at a density that increases in a direction away from the light incident surface.

12. The backlight module of claim 10, wherein the grooves are distributed on the light guide plate at a density increasing from both ends of the light guide plate to a center of the light guide plate.

13. The backlight module of claim 10, wherein the whole light guide plate is in the form of a flat plate.

14. A liquid crystal display device comprising a backlight module, wherein the backlight module comprises a light guide plate, the light guide plate is a optical transmissive plate and comprises at least one light incident surface for receiving light rays, one light exiting surface intersecting with the light incident surface, and one bottom surface opposite to the light exiting surface and formed with a plurality of grooves, the grooves are arranged on the bottom surface in a direction perpendicular to the light incident surface, and a first one of the grooves that is near the side of the light incident surface is 7.3 mm to 10.3 mm from the light incident surface.

15. The LCD device of claim 14, wherein each of the grooves has a cross section in a V-shape, a U-shape, an arc-shape or a trapezoidal shape.

16. The LCD device of claim 15, wherein the grooves are distributed at a density that increases in a direction away from the light incident surface.

17. The LCD device of claim 15, wherein the grooves are distributed on the light guide plate at a density increasing from both ends of the light guide plate to a center of the light guide plate.

18. The LCD device of claim 15, wherein the whole light guide plate is in the form of a flat plate.
